(19) United States
(12) Patent Application Publication
(10) Pub. No.: US 2023/0379755 A1
(43) Pub. Date: Nov. 23, 2023

(54) BUFFER STATUS REPORT AND SCHEDULING GRANT FOR TARGET UE IN SIDELINK RELAY

(71) Applicant: QUALCOMM Incorporated, San Diego, CA (US)

(72) Inventors: Hua WANG, Basking Ridge, NJ (US); Arumugam CHENDAMARAI KANNAN, San Diego, CA (US); Sony AKKARAKARAN, Poway, CA (US); Jung Ho RYU, Fort Lee, NJ (US); Tao LUO, San Diego, CA (US); Junyi LI, Fairless Hills, PA (US)

(21) Appl. No.: 17/664,146

(22) Filed: May 19, 2022

(51) Int. Cl. H04W 28/02; H04W 72/12; H04W 72/14

(52) U.S. Cl. CPC H04W 28/0278; H04W 72/1278; H04W 72/14; H04W 88/06

(57) ABSTRACT

Method and apparatus for BSR and scheduling grant for target UE in sidelink relay. The apparatus receives a request for sidelink communication from a target UE. The apparatus receives a first BSR from the target UE via the sidelink communication. The apparatus transmits a second BSR to a network entity, the second BSR comprising information corresponding to at least one of the first BSR of the target UE or a sidelink BSR for the relay UE. The apparatus receives an allocation of resources for the sidelink communication with the target UE based on the second BSR. The apparatus communicates via the sidelink communication with the target UE using the allocation of resources.

### TECHNICAL FIELD

The present disclosure relates generally to communication systems, and more particularly, to a configuration for transmitting a buffer status report (BSR) and scheduling grant for a target user equipment (UE) in sidelink relay.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a relay UE. The device may be a processor and/or a modem at a relay UE or the relay UE itself. The apparatus receives a request for sidelink communication from a target UE. The apparatus receives a first buffer status report (BSR) from the target UE via the sidelink communication. The apparatus transmits a second BSR to a network entity, the second BSR comprising information corresponding to at least one of the first BSR of the target UE or a sidelink BSR for the relay UE. The apparatus receives an allocation of resources for the sidelink communication with the target UE based on the second BSR. The apparatus communicates via the sidelink communication with the target UE using the allocation of resources.

In an aspect of the disclosure, a method, a computer-readable medium, and an apparatus are provided. The apparatus may be a device at a target UE. The device may be a processor and/or a modem at a target UE or the target UE itself. The apparatus transmits a request for sidelink communication with a relay UE. The apparatus transmits a first BSR to the relay UE via the sidelink communication. The apparatus communicates via the sidelink communication with the relay UE using an allocation of resources based at least on the first BSR.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates example aspects of sidelink communication between devices, in accordance with aspects presented herein.

FIG. 5 illustrates an example of a sidelink BSR within a MAC-CE, in accordance with aspects presented herein.

FIG. 6 illustrates an example of a sidelink BSR, in accordance with aspects presented herein.

FIG. 7 illustrates an example of a MAC-CE comprising multiple BSRs, in accordance with aspects presented herein.

FIG. 8 is a call flow diagram 800 of signaling between a relay UE and a target UE.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

### DETAILED DESCRIPTION

In sidelink communication (e.g., Mode 1), resource allocation may be provided by a network entity, such that the network entity determines resources for sidelink communication between UEs. For example, a sidelink transmitting UE may send a sidelink BSR to the network entity, and the network entity responds by sending, to the sidelink transmitting UE, a sidelink grant indicating resources to be used for sidelink transmission based on the sidelink BSR. However, in some instances, the quality of a direct link between the sidelink transmitting UE and the network entity may be bad or blocked. In such instances, the network entity may utilize a relay UE to forward uplink or downlink data to the sidelink transmitting UE. In yet some instances, there is no direct link between the sidelink transmitting UE to the network entity, such that the sidelink transmitting UE is unable to provide the network entity with a sidelink BSR. In order for the network entity to schedule resources for the sidelink transmitting UE to transmit data to the relay UE, the network entity would need the sidelink BSR from the sidelink transmitting UE. The sidelink transmitting UE may have a sidelink connection with the relay UE 506, but is unable to utilize the relay UE to relay the sidelink BSR to the network entity.

Aspects presented herein provide a configuration for providing a sidelink BSR of the target UE to the network entity in a sidelink relay configuration. The aspects presented herein may allow a relay UE to provide a network entity with a BSR from a target UE to configure sidelink communication resources.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip- level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

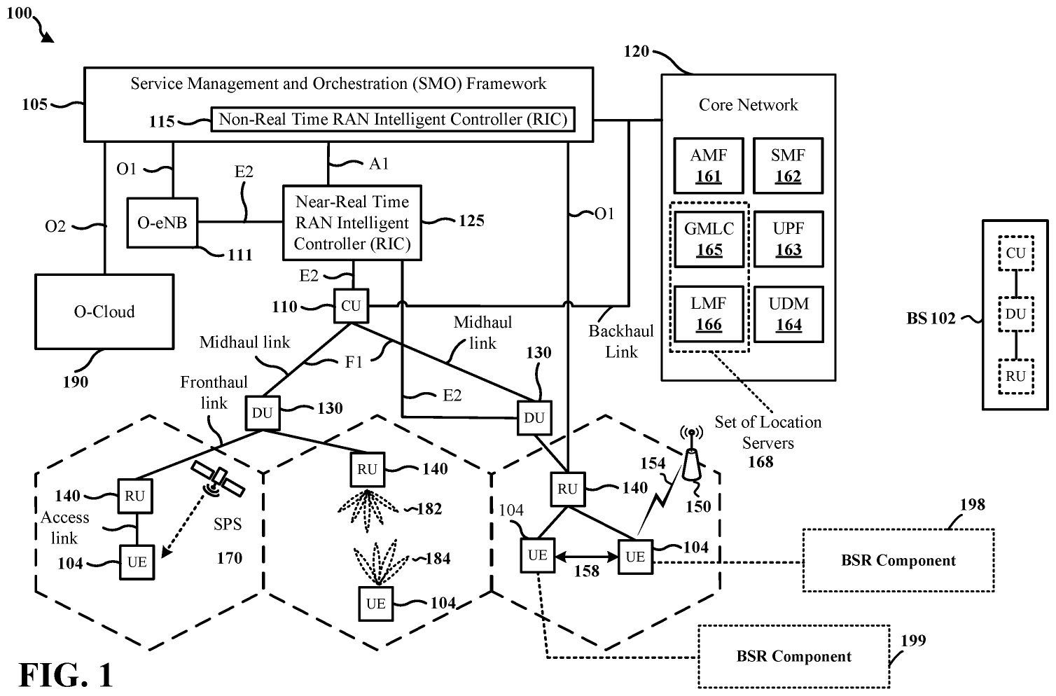

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

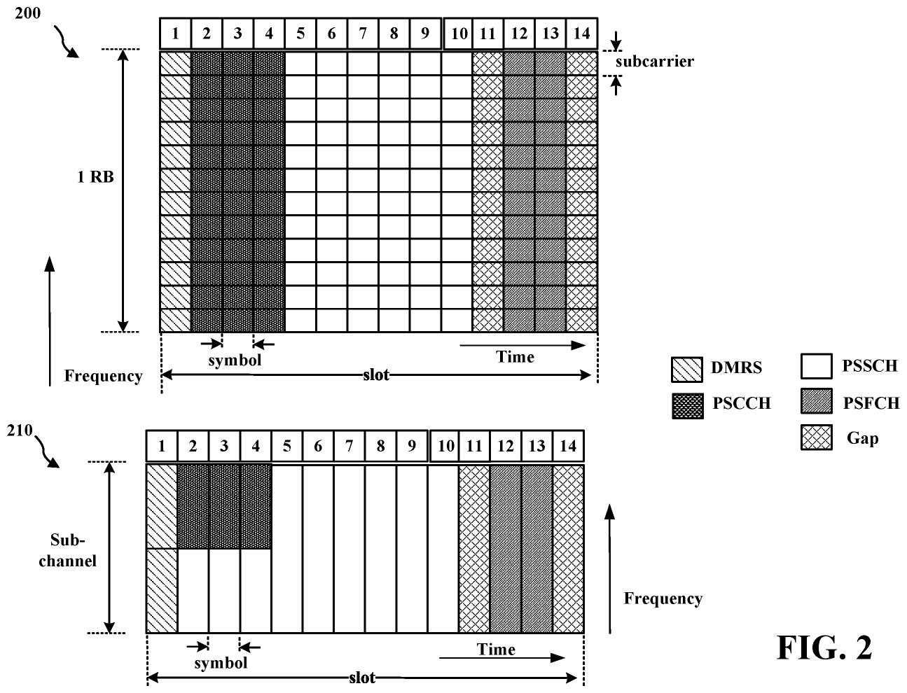

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the relay UE 104 may include a BSR component 198 configured to receive a request for sidelink communication from a target UE; receive a first buffer status report (BSR) from the target UE via the sidelink communication; transmit a second BSR to a network entity, the second BSR comprising information corresponding to at least one of the first BSR of the target UE or a sidelink BSR for the relay UE; receive an allocation of resources for the sidelink communication with the target UE based on the second BSR; and communicate via the sidelink communication with the target UE using the allocation of resources.

Referring again to FIG. 1, in certain aspects, the target UE 104 may include a BSR component 199 configured to transmit a request for sidelink communication with a relay UE; transmit a first BSR to the relay UE via the sidelink communication; and communicate via the sidelink communication with the relay UE using an allocation of resources based at least on the first BSR.

Although the following description may be focused on 5G NR, the concepts described herein may be applicable to other similar areas, such as LTE, LTE-A, CDMA, GSM, and other wireless technologies.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

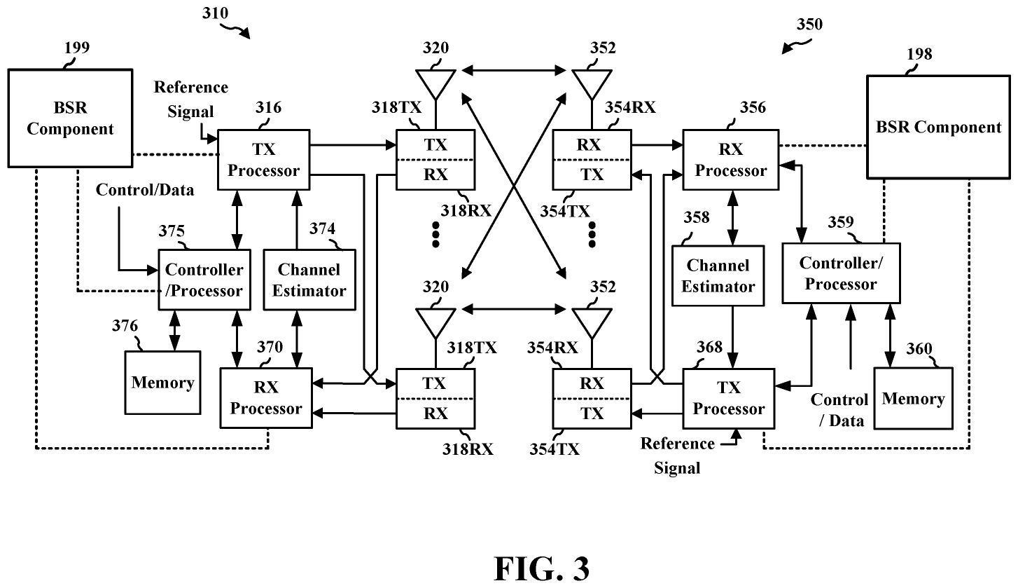

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate a radio frequency (RF) carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

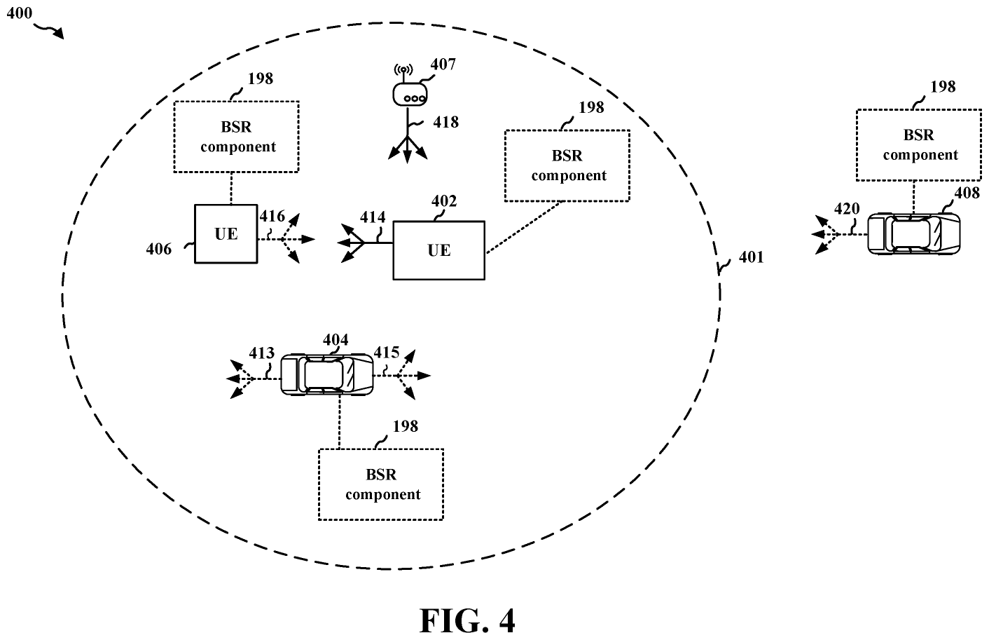

FIG. 4 illustrates an example 400 of sidelink communication between devices. The communication may be based on a slot structure comprising aspects described in connection with FIG. 2. For example, the UE 402 may transmit a sidelink transmission 414, e.g., comprising a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of TTIs, as well as the RBs that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit sidelink transmissions 413, 415 intended for receipt by other UEs within a range 401 of UE 404, and UE 406 may transmit sidelink transmission 416. Additionally/alternatively, RSU 407 may receive communication from and/or transmit communication 418 to UEs 402, 404, 406, 408. One or more of the UEs 402, 404, 406, 408 or the RSU 407 may comprise a BSR component 198 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 may determine resources for sidelink communication and may allocate resources to different UEs 104 to use for sidelink transmissions. In this first mode, a UE receives the allocation of sidelink resources from the base station 102. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

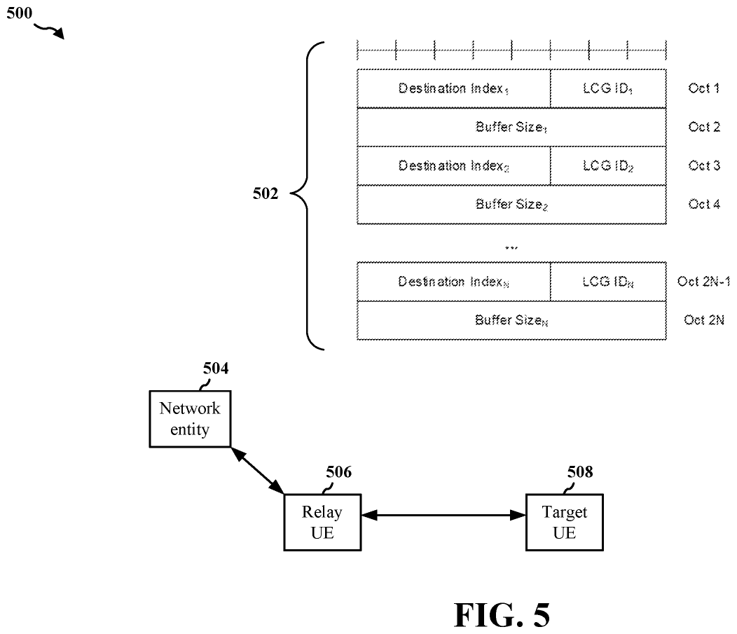

In sidelink communication (e.g., Mode 1), resource allocation may be provided by the network entity, such that the network entity determines resources for sidelink communication between UEs. For example, a sidelink transmitting UE may send a sidelink BSR 502 to the network entity, and the network entity responds by sending, to the sidelink transmitting UE, a sidelink grant indicating resources to be used for sidelink transmission based on the sidelink BSR 502. The sidelink BSR 502 may be within a MAC-CE, as shown in diagram 500 of FIG. 5. In some instances, the sidelink transmitting UE may have a plurality of receiving UEs in the sidelink transmission. The BSR 502, for each destination, identifies the receiving UE, the logic channel group identifier, as well as the buffer size.

However, in some instances, the quality of a direct link between the sidelink transmitting UE and the network entity may be bad or blocked. In such instances, the network entity 504 may utilize a relay UE 506 to forward uplink or downlink data to the sidelink transmitting UE (e.g., target UE 508). In yet some instances, there is no direct link between the sidelink transmitting UE 508 to the network entity 504, such that the sidelink transmitting UE 508 is unable to provide the network entity with a sidelink BSR. In order for the network entity to schedule resources for the sidelink transmitting UE 508 to transmit data to the relay UE 506, the network entity 504 would need the sidelink BSR from the sidelink transmitting UE 508. The sidelink transmitting UE 508 may have a sidelink connection with the relay UE 506, but is unable to utilize the relay UE 506 to relay the sidelink BSR to the network entity 504.

It is desirable for the network entity to control the sidelink resources for sidelink communication between the relay UE 506 and the target UE 508. For example, interference caused by the sidelink link between the relay UE 506 and the target UE 508 to the link (e.g., Uu) between the relay UE 506 and the network entity 504 may be limited or reduced. In addition, it is desirable for the network entity 504 to avoid scheduling downlink transmissions to the relay UE 506 and the target UE 508 to send uplink data to the relay UE 506 at the same slot. As such, for the network entity 504 to allocate resources for the relay UE 506, the network entity 504 should be informed of the buffer status of the relay UE 506. In instances where the relay UE 506 is to transmit data to the target UE 508, the relay UE 506 may send a sidelink BSR to the network entity 504 to request sidelink resources. However, in instances where the target UE 508 is to transmit data to the target UE 508, the target UE 508 is unable to provide the sidelink BSR to the network entity 504 and is unable to relay the sidelink BSR via the relay UE 506.

Aspects presented herein provide a configuration for providing a sidelink BSR of the target UE to the network entity in a sidelink relay configuration. The aspects presented herein may allow a relay UE to provide a network entity with a BSR from a target UE to configure sidelink communication resources. At least one advantage of the disclosure is that the network entity may be able to further limit or reduce interference caused by the sidelink link between a relay UE and a target UE. At least another advantage of the disclosure is that the network entity may have further control of the sidelink resources between the relay UE and the target UE, and may be able to avoid scheduling data conflicts between the relay UE and the target UE.

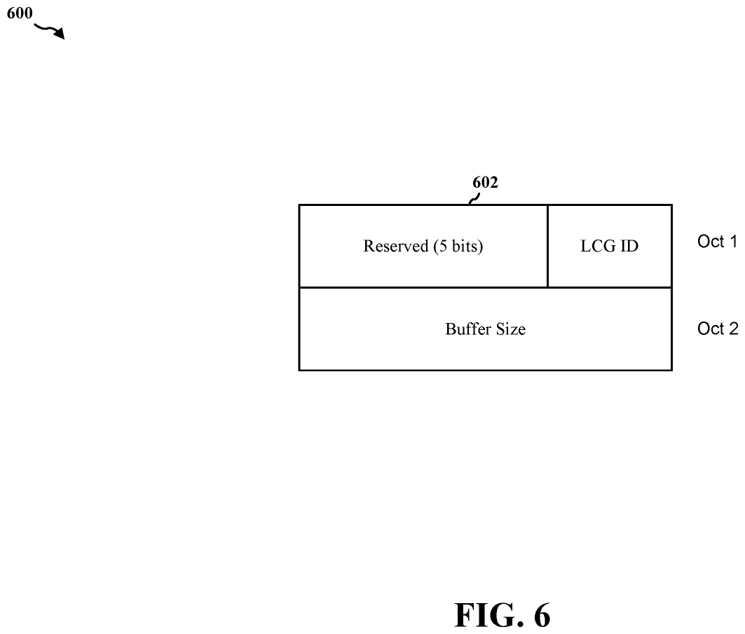

FIG. 6 provides an example of sidelink BSR of a target UE. The target UE may have a sidelink connection with a relay UE, while not have a connection with a network entity, while the relay UE has a connection (e.g., Uu) with the network entity. A sidelink target UE may send its sidelink BSR to a relay UE, such that the relay UE may provide the sidelink target UE to a network entity. The target UE may utilize a sidelink MAC-CE to transmit the sidelink BSR to the relay UE, as shown for example in diagram 600 of FIG. 6. The sidelink BSR 602 may include a LCG ID and a buffer size. The LCG ID may indicate the logical channel group that corresponds to the traffic in the buffer.

The relay UE may send the sidelink BSR of the target UE to the network entity. For example, the relay UE may use a Uu uplink MAC-CE to send the sidelink BSR of the target UE to the network entity. The MAC-CE may utilize a format similar to a sidelink BSR MAC-CE that includes a new field of the LCG ID to indicate that the Uu uplink MAC-CE is a sidelink BSR of the target UE, where the target UE ID is set as the destination ID.

In some instances, the relay UE may have its own BSRs and that of one or more target UEs that the relay UE has to provide to the network entity, yet there may only be one resource available to send one BSR report. In such instances, a priority may be utilized to determine which BSR report to send to the network entity. For example, the priority may indicate that the BSR of the relay UE is higher than the BSR of the target UE, the BSR of the target UE is higher than the BSR of the relay UE, the BSR with a larger buffer size has priority, or a combination thereof. In some aspects, the network entity may allocate different resources for the relay UE to send to the BSR report of the relay UE and the BSR report of the target UE.

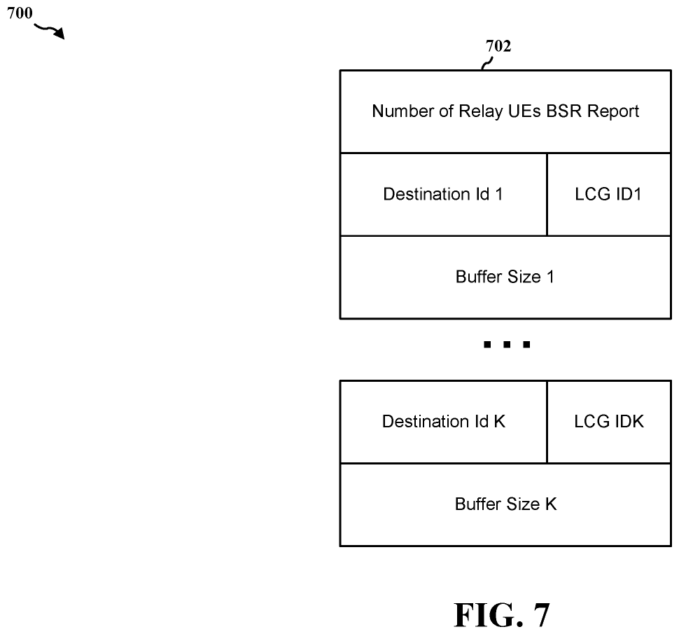

FIG. 7 provides an example of a MAC-CE comprising multiple BSRs. In some aspects, the relay UE may include the BSR of the relay UE and the BSR of one or more target UEs. For example, with reference to the diagram 700 of FIG. 7, the MAC-CE 702 may include the BSR of the relay UE and the BSR of the one or more target UEs. The MAC-CE 702 may include the BSR of the relay UE at the beginning, followed by the BSR of the one or more target UEs. For example, LCG ID1 may indicate the logical channel group that correspond to the BSR of the relay UE, and the buffer size 1 corresponding to the traffic in the buffer of the relay UE. The destination ID 1 may identify the relay UE. The BSR of the one or more target UE may follow and be identified accordingly. The number of BSRs of the one or more target UEs may be indicated in the first octet of the MAC-CE 702.

The network entity may utilize DCI (e.g., DCI 3_0) to grant sidelink resources to the relay UE, in order for the relay UE to forward downlink data from the network entity to the target UE. The network entity may send the sidelink resource grant to the relay UE for receiving sidelink data based on the BSR of the relay UE and/or the one or more target UEs, in order for the relay UE to receive uplink data from the target UE. The relay UE may forward the grant, received from the network entity, to the target UE to allow the target UE to send its uplink data to the relay UE via sidelink transmission. The target UE may then provide the uplink data of the target UE to the network entity. In some aspects, the grant from the network entity may be comprised within DCI (e.g., DCI 3_0), and use a bit to indicate that the grant is for sidelink transmission or sidelink reception. In some aspects, the grant from the network entity may be comprise within a downlink MAC-CE. The relay UE may forward the grant to the target UE via a sidelink MAC-CE. The base station may send a sidelink resource grant for the relay UE to forward the grant to the target UE, such that the target UE receives the grant from the relay UE and sends the uplink data to the relay UE as scheduled.

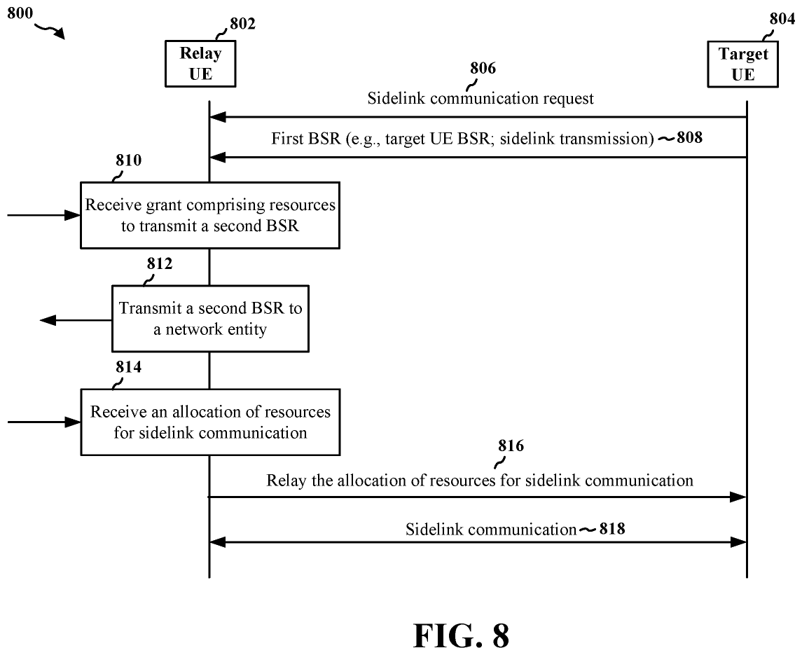

FIG. 8 is a call flow diagram 800 of signaling between a relay UE 802 and a target UE 804. The relay UE 802 may be configured to communicate with the base station (not shown). For example, in the context of FIG. 1, the relay UE 802 may correspond to at least UE 104, the target UE 804 may correspond to at least UE 104. In another example, in the context of FIG. 3, the target UE 804 may correspond to device 310 and the UE 802 may correspond to device 350.

At 806, the target UE 804 may transmit a request for sidelink communication. The target UE may transmit, to the relay UE 802, the request for the sidelink communication with the relay UE. The relay UE 802 may receive the request for the sidelink communication from the target UE 804.

At 808, the target UE 804 UE may transmit a first BSR to the relay UE 802. The target UE 804 may transmit the first BSR to the relay UE 802 via the sidelink communication. The relay UE 802 may receive the first BSR from the target UE 804. In some aspects, the first BSR may be transmitted via a sidelink MAC-CE. The first BSR may be transmitted, to the relay UE, via the sidelink MAC-CE.

At 810, the relay UE 802 may receive a grant comprising resources to transmit a second BSR. The relay UE 802 may receive the grant comprising resources to transmit the second BSR from a network entity (not shown). The grant may comprise different resources for the relay UE to transmit the information corresponding to the first BSR of the target UE or the sidelink BSR for the relay UE.

At 812, the relay UE 802 may transmit a second BSR to the network entity (not shown). The second BSR may comprise information corresponding to at least one of the first BSR of the target UE or a sidelink BSR for the relay UE. In some aspects, the second BSR may be transmitted via MAC-CE. A logical channel identifier (LCID) within a header of the MAC-CE may indicate that the second BSR is associated with at least one of the target UE or the relay UE. In some aspects, the second BSR may comprise the information corresponding to the first BSR. The second BSR may comprise a logical channel group identifier (LCGID) that may indicate that a logical channel group (LCG) within the second BSR corresponds to traffic information of the target UE. In some aspects, the second BSR may comprise the information corresponding to the sidelink BSR for the relay UE. The second BSR may comprise a LCGID that may indicate that a LCG within the second BSR corresponds to traffic information of the relay UE. In some aspects, the information corresponding to first BSR of the target UE and the sidelink BSR for the relay UE may be transmitted separately. Transmission of the first BSR of the target UE and the sidelink BSR for the relay UE may be based on a priority to determine which is sent first. In some aspects, the second BSR may comprise the first BSR of the target UE and the sidelink BSR of the relay UE. The second BSR may be ordered to include the sidelink BSR of the relay UE first and followed by the first BSR of the target UE.

At 814, the relay UE 802 may receive an allocation of resources for the sidelink communication with the target UE 804. The relay UE 802 may receive the allocation of resources for the sidelink communication with the target UE 804 from the network entity (not shown). The relay UE may receive the allocation of resources for the sidelink communication with the target UE based on the second BSR.

At 816, the relay UE 802 may relay the allocation of resources for the sidelink communication. The relay UE may relay the allocation of resources for the sidelink communication to the target UE 804. The target UE 804 may receive the allocation of resources for the sidelink communication from the relay UE 802.

At 818, the relay UE 802 may communicate via the sidelink communication with the target UE 804. The relay UE 802 may communication via the sidelink communication with the target UE 804 using the allocation of resources. The target UE may communicate via the sidelink communication with the relay UE using an allocation of resources based at least one the first BSR.

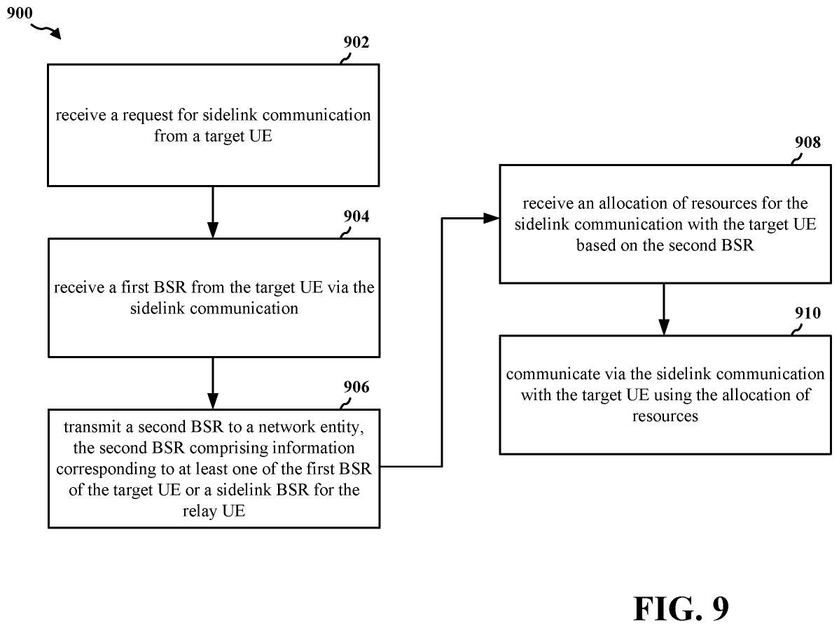

FIG. 9 is a flowchart 900 of a method of wireless communication. The method may be performed by a relay UE (e.g., the UE 104; the apparatus 1104). One or more of the illustrated operations may be omitted, transposed, or contemporaneous. The method may allow a relay UE to provide a network entity with a BSR from a target UE to configure sidelink communication resources.

At 902, the relay UE may receive a request for sidelink communication. For example, 902 may be performed by BSR component 198 of apparatus 1104. The relay UE may receive the request for the sidelink communication from a target UE.

At 904, the relay UE may receive a first BSR from the target UE. For example, 904 may be performed by BSR component 198 of apparatus 1104. The relay UE may receive the first BSR from the target UE via the sidelink communication. In some aspects, the first BSR may be received via a sidelink MAC-CE from the target UE.

At 906, the relay UE may transmit a second BSR to a network entity. For example, 906 may be performed by BSR component 198 of apparatus 1104. The second BSR may comprise information corresponding to at least one of the first BSR of the target UE or a sidelink BSR for the relay UE. In some aspects, the second BSR may be transmitted via MAC-CE. A LCID within a header of the MAC-CE may indicate that the second BSR is associated with at least one of the target UE or the relay UE. In some aspects, the second BSR may comprise the information corresponding to the first BSR. The second BSR may comprise a LCGID that may indicate that a LCG within the second BSR corresponds to traffic information of the target UE. In some aspects, the second BSR may comprise the information corresponding to the sidelink BSR for the relay UE. The second BSR may comprise a LCGID that may indicate that a LCG within the second BSR corresponds to traffic information of the relay UE. In some aspects, the information corresponding to first BSR of the target UE and the sidelink BSR for the relay UE may be transmitted separately. Transmission of the first BSR of the target UE and the sidelink BSR for the relay UE may be based on a priority to determine which is sent first. In some aspects, the second BSR may comprise the first BSR of the target UE and the sidelink BSR of the relay UE. The second BSR may be ordered to include the sidelink BSR of the relay UE first and followed by the first BSR of the target UE.

At 908, the relay UE may receive an allocation of resources for the sidelink communication with the target UE. For example, 908 may be performed by BSR component 198 of apparatus 1104. The relay UE may receive the allocation of resources for the sidelink communication with the target UE based on the second BSR.

At 910, the relay UE may communicate via the sidelink communication with the target UE. For example, 910 may be performed by BSR component 198 of apparatus 1104. The relay UE may communication via the sidelink communication with the target UE using the allocation of resources.

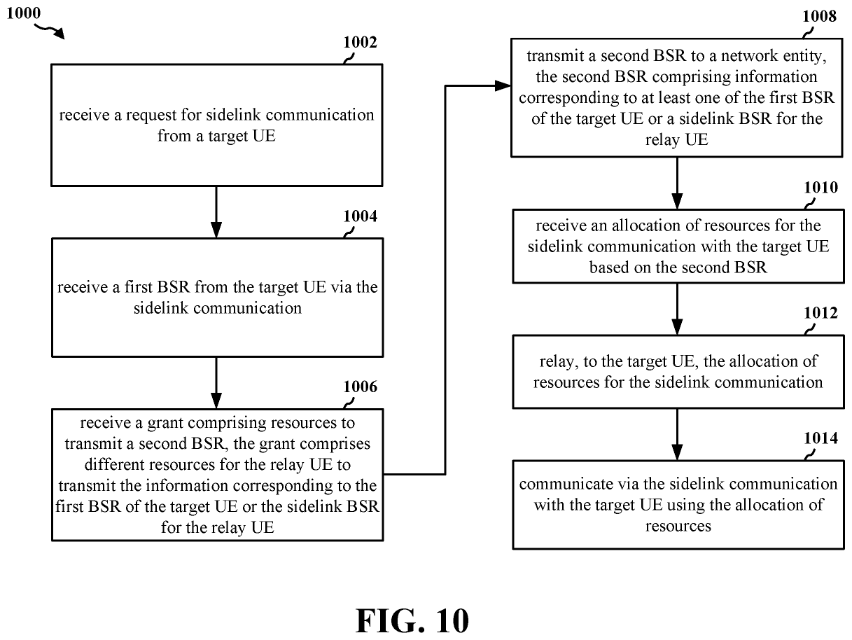

FIG. 10 is a flowchart 1000 of a method of wireless communication. The method may be performed by a UE (e.g., the UE 104; the apparatus 1104). One or more of the illustrated operations may be omitted, transposed, or contemporaneous. The method may allow a relay UE to provide a network entity with a BSR from a target UE to configure sidelink communication resources

At 1002, the relay UE may receive a request for sidelink communication. For example, 1002 may be performed by BSR component 198 of apparatus 1104. The relay UE may receive the request for the sidelink communication from a target UE.

At 1004, the relay UE may receive a first BSR from the target UE. For example, 1004 may be performed by BSR component 198 of apparatus 1104. The relay UE may receive the first BSR from the target UE via the sidelink communication. In some aspects, the first BSR may be received via a sidelink MAC-CE from the target UE.

At 1006, the relay UE may receive a grant comprising resources to transmit the second BSR. For example, 1006 may be performed by BSR component 198 of apparatus 1104. The grant may comprise different resources for the relay UE to transmit the information corresponding to the first BSR of the target UE or the sidelink BSR for the relay UE.

At 1008, the relay UE may transmit a second BSR to a network entity. For example, 1008 may be performed by BSR component 198 of apparatus 1104. The second BSR may comprise information corresponding to at least one of the first BSR of the target UE or a sidelink BSR for the relay UE. In some aspects, the second BSR may be transmitted via a MAC-CE. A LCID within a header of the MAC-CE may indicate that the second BSR is associated with at least one of the target UE or the relay UE. In some aspects, the second BSR may comprise the information corresponding to the first BSR. The second BSR may comprise a LCGID that may indicate that an LCG within the second BSR corresponds to traffic information of the target UE. In some aspects, the second BSR may comprise the information corresponding to the sidelink BSR for the relay UE. The second BSR may comprise a LCGID that may indicate that an LCG within the second BSR corresponds to traffic information of the relay UE. In some aspects, the information corresponding to first BSR of the target UE and the sidelink BSR for the relay UE may be transmitted separately. Transmission of the first BSR of the target UE and the sidelink BSR for the relay UE may be based on a priority to determine which is sent first. In some aspects, the second BSR may comprise the first BSR of the target UE and the sidelink BSR of the relay UE. The second BSR may be ordered to include the sidelink BSR of the relay UE first and followed by the first BSR of the target UE.

At 1010, the relay UE may receive an allocation of resources for the sidelink communication with the target UE. For example, 1010 may be performed by BSR component 198 of apparatus 1104. The relay UE may receive the allocation of resources for the sidelink communication with the target UE based on the second BSR.

At 1012, the relay UE may relay the allocation of resources for the sidelink communication. For example, 1012 may be performed by BSR component 198 of apparatus 1104. The relay UE may relay, to the target UE, the allocation of resources for the sidelink communication.

At 1014, the relay UE may communicate via the sidelink communication with the target UE. For example, 1014 may be performed by BSR component 198 of apparatus 1104. The relay UE may communication via the sidelink communication with the target UE using the allocation of resources.

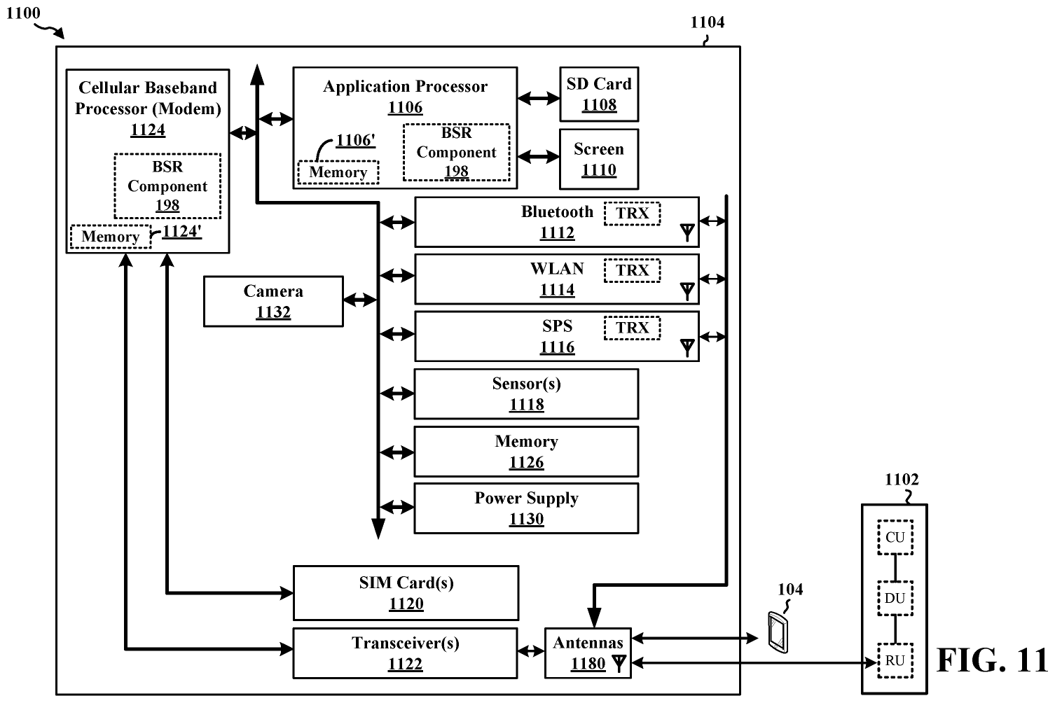

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the device 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to receive a request for sidelink communication from a target UE; receiving a first BSR from the target UE via the sidelink communication; transmit a second BSR to a network entity, the second BSR comprising information corresponding to at least one of the first BSR of the target UE or a sidelink BSR for the relay UE; receive an allocation of resources for the sidelink communication with the target UE based on the second BSR; and communicate via the sidelink communication with the target UE using the allocation of resources. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for receiving a request for sidelink communication from a target UE. The apparatus includes means for receiving a first buffer status report (BSR) from the target UE via the sidelink communication. The apparatus includes means for transmitting a second BSR to a network entity, the second BSR comprising information corresponding to at least one of the first BSR of the target UE or a sidelink BSR for the relay UE. The apparatus includes means for receiving an allocation of resources for the sidelink communication with the target UE based on the second BSR. The apparatus includes means for communicating via the sidelink communication with the target UE using the allocation of resources. The apparatus further includes means for receiving a grant comprising resources to transmit the second BSR. The grant comprises different resources for the relay UE to transmit the information corresponding to the first BSR of the target UE or the sidelink BSR for the relay UE. The apparatus further includes means for relaying, to the target UE, the allocation of resources for the sidelink communication. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

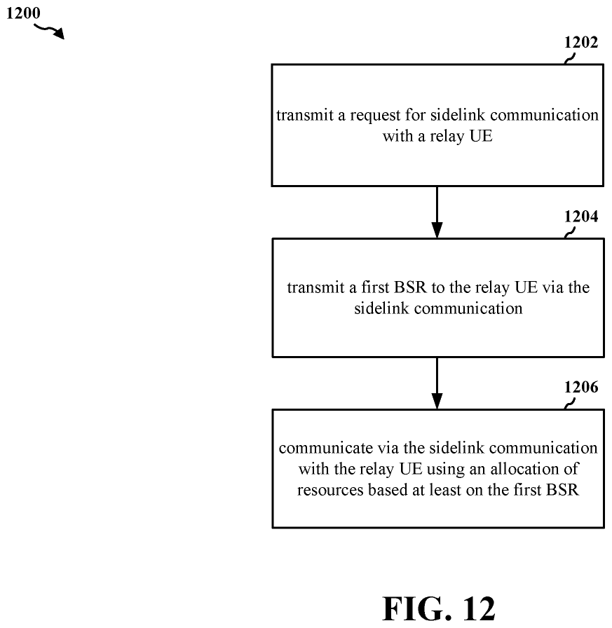

FIG. 12 is a flowchart 1200 of a method of wireless communication. The method may be performed by a target UE (e.g., the UE 104; the apparatus 1404). One or more of the illustrated operations may be omitted, transposed, or contemporaneous. The method may allow a target UE to provide a BSR to a relay UE via sidelink, such that the relay UE provides a network entity with the BSR from the target UE to configure sidelink communication resources.

At 1202, the target UE may transmit a request for sidelink communication. For example, 1202 may be performed by BSR component 199 of apparatus 1404. The target UE may transmit the request for the sidelink communication with a relay UE. The target UE may transmit, to the relay UE, the request for the sidelink communication with the relay UE.

At 1204, the target UE may transmit a first BSR to the relay UE. For example, 1204 may be performed by BSR component 199 of apparatus 1404. The target UE may transmit the first BSR to the relay UE via the sidelink communication. In some aspects, the first BSR may be transmitted via a sidelink MAC-CE. The first BSR may be transmitted, to the relay UE, via the sidelink MAC-CE.

At 1206, the target UE may communicate via the sidelink communication with the relay UE. For example, 1206 may be performed by BSR component 199 of apparatus 1404. The target UE may communicate via the sidelink communication with the relay UE using an allocation of resources based at least one the first BSR.

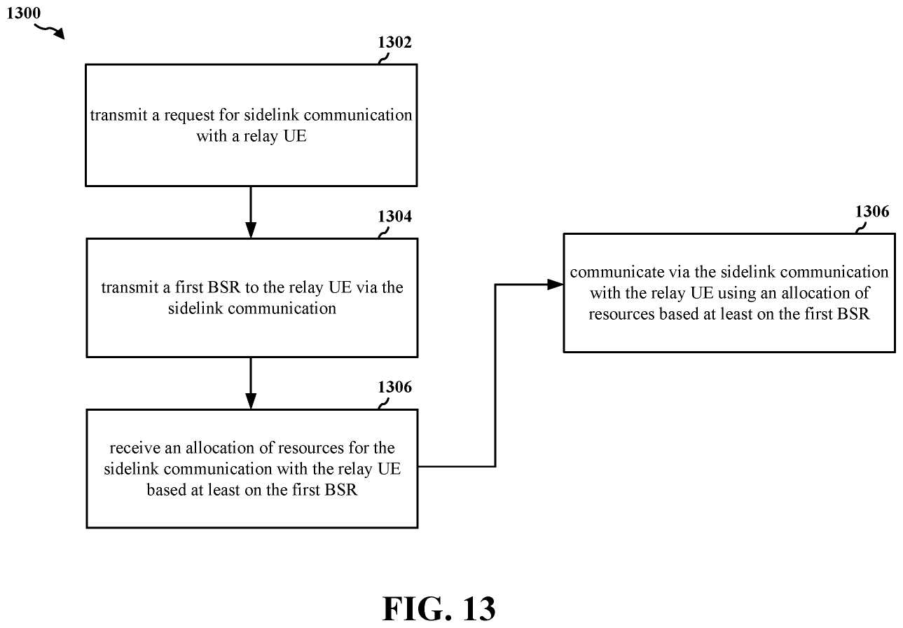

FIG. 13 is a flowchart 1300 of a method of wireless communication. The method may be performed by a UE (e.g., the UE 104; the apparatus 1404). One or more of the illustrated operations may be omitted, transposed, or contemporaneous. The method may allow a target UE to provide a BSR to a relay UE via sidelink, such that the relay UE provides a network entity with the BSR from the target UE to configure sidelink communication resources.

At 1302, the target UE may transmit a request for sidelink communication. For example, 1302 may be performed by BSR component 199 of apparatus 1404. The target UE may transmit the request for the sidelink communication with a relay UE. The target UE may transmit, to the relay UE, the request for the sidelink communication with the relay UE.

At 1304, the target UE may transmit a first BSR to the relay UE. For example, 1304 may be performed by BSR component 199 of apparatus 1404. The target UE may transmit the first BSR to the relay UE via the sidelink communication. In some aspects, the first BSR may be transmitted via a sidelink MAC-CE. The first BSR may be transmitted, to the relay UE, via the sidelink MAC-CE.

At 1306, the target UE may receive an allocation of resources for the sidelink communication with the relay UE. For example, 1306 may be performed by BSR component 199 of apparatus 1404. The target UE may receive the allocation of resources for the sidelink communication with the relay UE base at least on the first BSR. In some aspects, the allocation of resources for the sidelink communication may be received, from the relay UE, within a sidelink MAC-CE.

At 1308, the target UE may communicate via the sidelink communication with the relay UE. For example, 1308 may be performed by BSR component 199 of apparatus 1404. The target UE may communicate via the sidelink communication with the relay UE using an allocation of resources based at least one the first BSR.

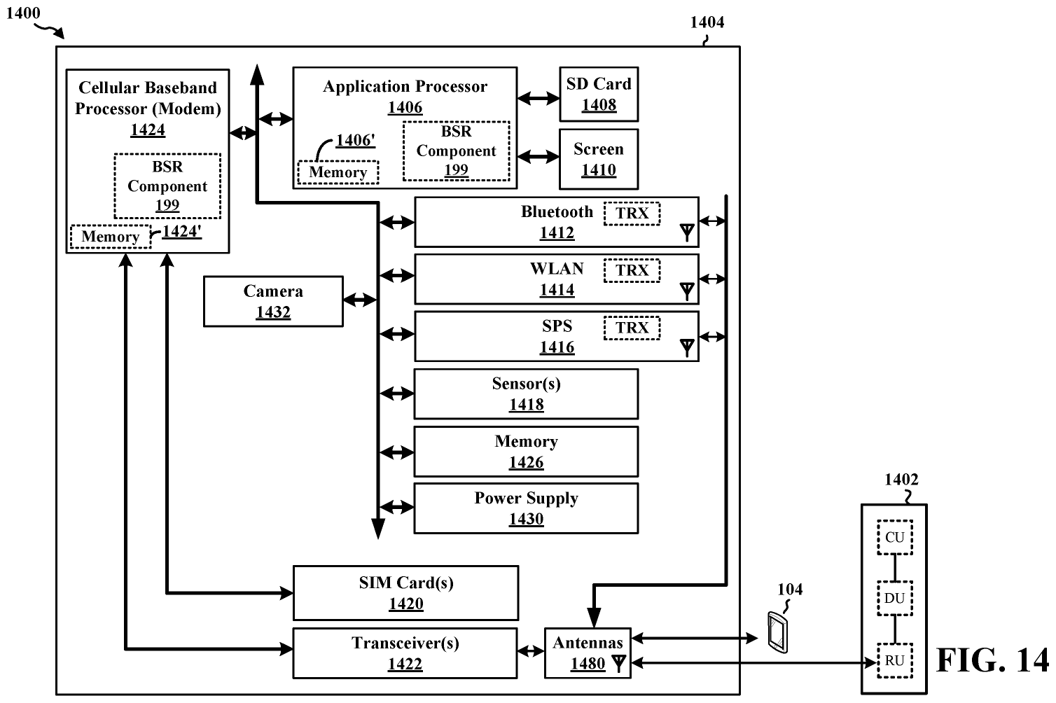

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the device 310 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 310 of FIG. 3) and include the additional modules of the apparatus 1404.

As discussed supra, the component 199 is configured to transmit a request for sidelink communication with a relay UE; transmit a first buffer status report (BSR) to the relay UE via the sidelink communication; and communicate via the sidelink communication with the relay UE using an allocation of resources based at least on the first BSR. The component 199 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for transmitting a request for sidelink communication with a relay UE. The apparatus includes means for transmitting a first BSR to the relay UE via the sidelink communication. The apparatus includes means for communicating via the sidelink communication with the relay UE using an allocation of resources based at least on the first BSR. The apparatus further includes means for receiving the allocation of resources for the sidelink communication with the relay UE based at least on the first BSR. The means may be the component 199 of the apparatus 1404 configured to perform the functions recited by the means. As described supra, the apparatus 1404 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a relay UE, comprising receiving a request for sidelink communication from a target UE; receiving a first BSR from the target UE via the sidelink communication; transmitting a second BSR to a network entity, the second BSR comprising information corresponding to at least one of the first BSR of the target UE or a sidelink BSR for the relay UE; receiving an allocation of resources for the sidelink communication with the target UE based on the second BSR; and communicating via the sidelink communication with the target UE using the allocation of resources.

Aspect 2 is the method of aspect 1, further includes that the first BSR is received via a sidelink MAC-CE.

Aspect 3 is the method of any of aspects 1 and 2, further includes that the second BSR is transmitted via a MAC-CE, wherein a logical channel identifier (LCID) within a header of the MAC-CE indicates that the second BSR is associated with at least one of the target UE or the relay UE.

Aspect 4 is the method of any of aspects 1-3, further includes that the second BSR comprises the information corresponding to the first BSR, wherein the second BSR comprises a LCGID indicating that an LCG within the second BSR corresponds to traffic information of the target UE.

Aspect 5 is the method of any of aspects 1-4, further includes that the second BSR comprises the information corresponding to the sidelink BSR for the relay UE, wherein the second BSR comprises a LCGID indicating that an LCG within the second BSR corresponds to traffic information of the relay UE.

Aspect 6 is the method of any of aspects 1-5, further includes that the information corresponding to first BSR of the target UE and the sidelink BSR for the relay UE are transmitted separately.

Aspect 7 is the method of any of aspects 1-6, further includes that transmission of the first BSR of the target UE and the sidelink BSR for the relay UE is based on a priority to determine which is sent first.

Aspect 8 is the method of any of aspects 1-7, further including receiving a grant comprising resources to transmit the second BSR, wherein the grant comprises different resources for the relay UE to transmit the information corresponding to the first BSR of the target UE or the sidelink BSR for the relay UE.

Aspect 9 is the method of any of aspects 1-8, further includes that the second BSR comprises the first BSR of the target UE and the sidelink BSR of the relay UE.

Aspect 10 is the method of any of aspects 1-9, further includes that the second BSR is ordered to include the sidelink BSR of the relay UE first and followed by the first BSR of the target UE.

Aspect 11 is the method of any of aspects 1-10, further including relay, to the target UE, the allocation of resources for the sidelink communication.

Aspect 12 is an apparatus for wireless communication at a relay UE including at least one processor coupled to a memory and at least one transceiver, the at least one processor configured to implement any of Aspects 1-11.

Aspect 13 is an apparatus for wireless communication at a relay UE including means for implementing any of Aspects 1-11.

Aspect 14 is a computer-readable medium storing computer executable code, where the code when executed by a processor causes the processor to implement any of Aspects 1-11.

Aspect 15 is a method of wireless communication at a target UE, comprising transmitting a request for sidelink communication with a relay UE; transmitting a first BSR to the relay UE via the sidelink communication; and communicating via the sidelink communication with the relay UE using an allocation of resources based at least on the first BSR.

Aspect 16 is the method of aspect 15, further includes that the first BSR is transmitted via a sidelink MAC-CE.

Aspect 17 is the method of any of aspects 15 and 16, further including receiving the allocation of resources for the sidelink communication with the relay UE based at least on the first BSR.

Aspect 18 is the method of any of aspects 15-17, further includes that the allocation of resources for the sidelink communication are received within a sidelink MAC-CE.

Aspect 19 is an apparatus for wireless communication at a target UE including at least one processor coupled to a memory and at least one transceiver, the at least one processor configured to implement any of Aspects 15-18.

Aspect 20 is an apparatus for wireless communication at a target UE including means for implementing any of Aspects 15-18.

Aspect 21 is a computer-readable medium storing computer executable code, where the code when executed by a processor causes the processor to implement any of Aspects 15-18.

What is claimed is:

1. An apparatus for wireless communication at a relay user equipment (UE), comprising:
a memory; and
at least one processor coupled to the memory and, based at least in part on information stored in the memory, the at least one processor is configured to:
receive a request for sidelink communication from a target UE;
receive a first buffer status report (BSR) from the target UE via the sidelink communication;
transmit a second BSR to a network entity, the second BSR comprising information corresponding to at least one of the first BSR of the target UE or a sidelink BSR for the relay UE;
receive an allocation of resources for the sidelink communication with the target UE based on the second BSR; and
communicate via the sidelink communication with the target UE using the allocation of resources.

2. The apparatus of claim 1, further comprising a transceiver coupled to the at least one processor.

3. The apparatus of claim 1, wherein the first BSR is received via a sidelink medium access control (MAC) control element (CE) (MAC-CE).

4. The apparatus of claim 1, wherein the second BSR is transmitted via a medium access control (MAC) control element (CE) (MAC-CE), wherein a logical channel identifier (LCID) within a header of the MAC-CE indicates that the second BSR is associated with at least one of the target UE or the relay UE.

5. The apparatus of claim 1, wherein the second BSR comprises the information corresponding to the first BSR, wherein the second BSR comprises a logical channel group identifier (LCGID) indicating that a logical channel group (LCG) within the second BSR corresponds to traffic information of the target UE.

6. The apparatus of claim 1, wherein the second BSR comprises the information corresponding to the sidelink BSR for the relay UE, wherein the second BSR comprises a logical channel group identifier (LCGID) indicating that a logical channel group (LCG) within the second BSR corresponds to traffic information of the relay UE.

7. The apparatus of claim 1, wherein the information corresponding to first BSR of the target UE and the sidelink BSR for the relay UE are transmitted separately.

8. The apparatus of claim 7, wherein transmission of the first BSR of the target UE and the sidelink BSR for the relay UE is based on a priority to determine which is sent first.

9. The apparatus of claim 1, wherein the at least one processor is further configured to:
receive a grant comprising resources to transmit the second BSR, wherein the grant comprises different resources for the relay UE to transmit the information corresponding to the first BSR of the target UE or the sidelink BSR for the relay UE.

10. The apparatus of claim 1, wherein the second BSR comprises the first BSR of the target UE and the sidelink BSR of the relay UE.

11. The apparatus of claim 10, wherein the second BSR is ordered to include the sidelink BSR of the relay UE first and followed by the first BSR of the target UE.

12. The apparatus of claim 1, wherein the at least one processor is further configured to:
relay, to the target UE, the allocation of resources for the sidelink communication.

13. A method of wireless communication at a relay user equipment (UE), comprising:
receiving a request for sidelink communication from a target UE;
receiving a first buffer status report (BSR) from the target UE via the sidelink communication;
transmitting a second BSR to a network entity, the second BSR comprising information corresponding to at least one of the first BSR of the target UE or a sidelink BSR for the relay UE;
receiving an allocation of resources for the sidelink communication with the target UE based on the second BSR; and
communicating via the sidelink communication with the target UE using the allocation of resources.

14. The method of claim 13, wherein the first BSR is received via a sidelink MAC-CE.

15. The method of claim 13, wherein the second BSR is transmitted via a MAC-CE, wherein a logical channel identifier (LCID) within a header of the MAC-CE indicates that the second BSR is associated with at least one of the target UE or the relay UE.

16. The method of claim 13, wherein the second BSR comprises the information corresponding to the first BSR, wherein the second BSR comprises a logical channel group identifier (LCGID) indicating that a logical channel group (LCG) within the second BSR corresponds to traffic information of the target UE.

17. The method of claim 13, wherein the second BSR comprises the information corresponding to the sidelink BSR for the relay UE, wherein the second BSR comprises a logical channel group identifier (LCGID) indicating that a logical channel group (LCG) within the second BSR corresponds to traffic information of the relay UE.

18. The method of claim 13, wherein the information corresponding to first BSR of the target UE and the sidelink BSR for the relay UE are transmitted separately.

19. The method of claim 18, wherein transmission of the first BSR of the target UE and the sidelink BSR for the relay UE is based on a priority to determine which is sent first.

20. The method of claim 13, further comprising:
receiving a grant comprising resources to transmit the second BSR, wherein the grant comprises different resources for the relay UE to transmit the information corresponding to the first BSR of the target UE or the sidelink BSR for the relay UE.

21. The method of claim 13, wherein the second BSR comprises the first BSR of the target UE and the sidelink BSR of the relay UE.

22. The method of claim 21, wherein the second BSR is ordered to include the sidelink BSR of the relay UE first and followed by the first BSR of the target UE.

23. The method of claim 13, further comprising:
relaying, to the target UE, the allocation of resources for the sidelink communication.

24. An apparatus for wireless communication at a target user equipment (UE), comprising:
a memory; and
at least one processor coupled to the memory and, based at least in part on information stored in the memory, the at least one processor is configured to:
transmit a request for sidelink communication with a relay UE;
transmit a first buffer status report (BSR) to the relay UE via the sidelink communication; and
communicate via the sidelink communication with the relay UE using an allocation of resources based at least on the first BSR.

25. The apparatus of claim 24, further comprising a transceiver coupled to the at least one processor.

26. The apparatus of claim 24, wherein the first BSR is transmitted via a sidelink medium access control (MAC) control element (CE) (MAC-CE).

27. The apparatus of claim 24, wherein the at least one processor is further configured to:
receive the allocation of resources for the sidelink communication with the relay UE based at least on the first BSR.

28. The apparatus of claim 27, wherein the allocation of resources for the sidelink communication are received within a sidelink medium access control (MAC) control element (CE) (MAC-CE).

29. A method of wireless communication at a target user equipment (UE), comprising:
transmitting a request for sidelink communication with a relay UE;
transmitting a first buffer status report (BSR) to the relay UE via the sidelink communication; and
communicating via the sidelink communication with the relay UE using an allocation of resources based at least on the first BSR.

30. The method of claim 29, further comprising:
receiving the allocation of resources for the sidelink communication with the relay UE based at least on the first BSR.
